(19) United States
(12) Patent Application Publication
(10) Pub. No.: US 2013/0151504 A1
(43) Pub. Date: Jun. 13, 2013

(54) QUERY PROGRESS ESTIMATION

(71) Applicants: Christian Konig, Kirkland, WA (US); Bolin Ding, Urbana, IL (US); Surajit Chaudhuri, Seattle, WA (US); Vivek Narasayya, Redmond, WA (US)

(72) Inventors: Christian Konig, Kirkland, WA (US); Bolin Ding, Urbana, IL (US); Surajit Chaudhuri, Seattle, WA (US); Vivek Narasayya, Redmond, WA (US)

(73) Assignee: MICROSOFT CORPORATION, Redmond, WA (US)

(21) Appl. No.: 13/315,306

(22) Filed: Dec. 9, 2011

(51) Int. Cl. G06F 17/30

(52) U.S. Cl. 707/718; 707/E17.132

(57) ABSTRACT

The claimed subject matter provides a method for providing a progress estimate for a database query. The method includes determining static features of a query plan for the database query. The method also includes selecting an initial progress estimator based on the static features and a trained machine learning model. The model is trained using static features of a plurality of query plans, and dynamic features of the plurality of query plans. Further, the method includes determining dynamic features of the query plan for each of a plurality of candidate estimators. Additionally, the method includes selecting a revised progress estimator based on the static features, the dynamic features and a trained machine learning model for each of the candidate estimators. The method further includes producing the progress estimate based on the revised progress estimator.

### BACKGROUND

Accurate estimation of the progress of database queries can be useful for a number of applications, such as the administration of long-running decision support queries. Typical applications of progress estimation include deciding whether to cancel a long-running query. In such scenarios, the consequence of inaccurate estimates increases the computational costs of the queries.

In progress estimation, estimator application predict how long a query will run, with some guarantee of correctness in a specific percentile range. Because of the complexity involved in creating these estimators, the estimators typically strive to achieve small overhead, small memory footprints, and robustness. Robustness in this context means that the estimators are accurate across a wide range of different types of queries, parameters, and data distributions. Unfortunately, the problem of accurate progress estimation for different variations of these factors is challenging in terms of worst-case guarantees. Typically, such techniques merely guarantee trivial bounds on the accuracy of the estimation. Some techniques only provide guarantees when some common query operators are disallowed. As such, unless targeted at specific types of queries, the typical estimators perform poorly in relation to some alternative estimators for many queries.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The claimed subject matter provides a method for providing a progress estimate for a database query. The method includes determining static features of a query plan for the database query. The method also includes selecting an initial progress estimator based on the static features and a trained machine learning model. The model is trained using static features of a plurality of query plans, and dynamic features of the plurality of query plans. Further, the method includes determining dynamic features of the query plan for each of a plurality of candidate estimators. Additionally, the method includes selecting a revised progress estimator based on the static features, the dynamic features and a trained machine learning model for each of the candidate estimators. The method further includes generating the progress estimate based on the revised progress estimator.

The claimed subject matter provides a system for providing a progress estimate for a database query. The system includes a processing unit and a system memory. The system memory includes code configured to determine static features of a query plan of the database query. The static features include metrics about the query plan determined before execution of the query plan. An initial progress estimator is selected based on the static features. Dynamic features of the query plan are determine for each of a plurality of candidate estimators. The dynamic features include metrics about an execution of the query plan. A revised progress estimator is selected based on the static features, the dynamic features and a trained machine learning model for each of the candidate estimators. The progress estimate is generated based on the revised progress estimator. The progress estimate is more accurate than the initial progress estimate.

Additionally, the claimed subject matter includes a computer-readable storage media. The computer-readable storage media includes code configured to direct a processing unit to determine static features of a pipeline of a query plan for a database query. An initial progress estimator is selected for the pipeline based on the static features. Dynamic features of the pipeline are determined for each of a plurality of candidate estimators. The dynamic features include metrics about an execution of the pipeline. A revised progress estimator is selected based on the static features, the dynamic features and a trained regression model for each of the candidate estimators. The progress estimate is generated based on the revised progress estimator. The progress estimate is more accurate than the initial progress estimate.

The following description and the annexed drawings set forth in detail certain illustrative aspects of the claimed subject matter. These aspects are indicative, however, of a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 is a system for query progress estimation operating in accordance with the claimed subject matter;

FIG. 2 is a block diagram of a query plan, in accordance with the claimed subject matter;

FIG. 3 is a process flow diagram of a method for selecting the progress estimator, in accordance with the claimed subject matter;

FIG. 4 is a block diagram of an exemplary networking environment for implementing various aspects of the claimed subject matter; and

FIG. 5 is a block diagram of an exemplary operating environment for implementing various aspects of the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, the terms “component,” “system,” “client” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware.

By way of illustration, both an application running on a server and the server can be a component. One or more components can reside within a process and a component can be localized on one computer and/or distributed between two or more computers. The term “processor” is generally understood to refer to a hardware component, such as a processing unit of a computer system.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any non-transitory computer-readable device, or media.

Non-transitory computer-readable storage media can include but are not limited to magnetic storage devices (e.g., hard disk, floppy disk, and magnetic strips, among others), optical disks (e.g., compact disk (CD), and digital versatile disk (DVD), among others), smart cards, and flash memory devices (e.g., card, stick, and key drive, among others). In contrast, computer-readable media generally (i.e., not necessarily storage media) may additionally include communication media such as transmission media for wireless signals and the like.

Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

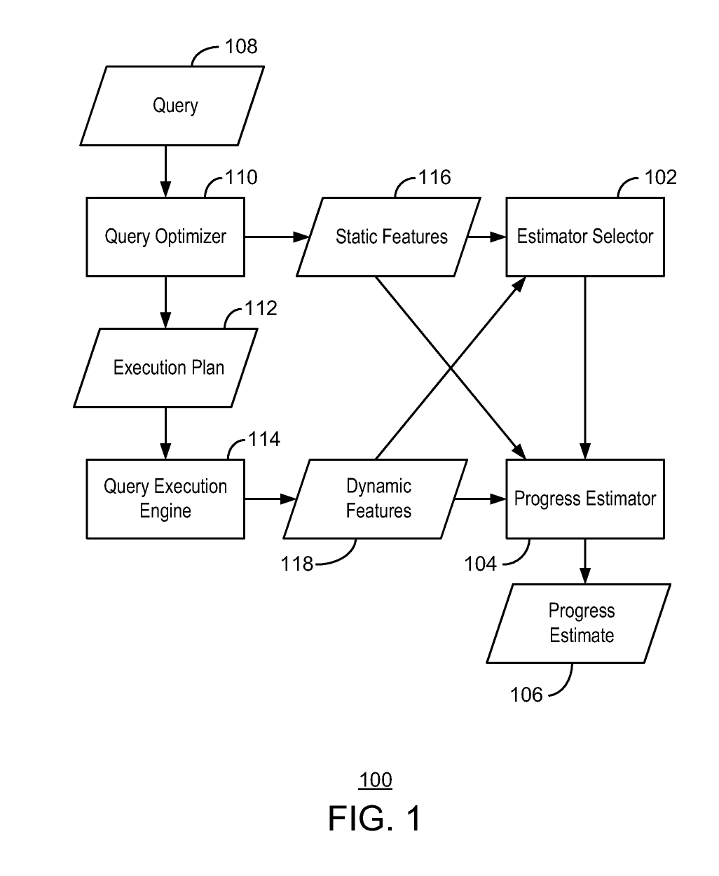

FIG. 1 is a system 100 for query progress estimation, operating in accordance with the claimed subject matter. The system 100 includes a selector 102 of progress estimators 104, a progress estimate 106, queries 108, a query optimizer 110, a query plan 112, a query execution engine 114, static features 116, and dynamic features 118.

The selector 102 decides which progress estimator 104, among a given set of candidate estimators, to use for progress estimation. The progress estimator 104 bases the progress estimate 106 on GetNext calls. GetNext calls are a standard abstraction used in many database management systems. A GetNext call refer to the pull-based retrieval of a database tuple used in the standard iterator model of database query processing. The progress estimator 104 assumes the total amount of work performed by the query 108 is amortized across a weighted combination of all the GetNext calls issued by the query 108. Work may include computational costs, such as CPU overhead and processing costs for I/O. By knowing the total number of GetNext calls, it is possible to estimate progress by knowing how many calls have been made at a specific point in execution. The candidates for the progress estimator 104 may include, for example, a Driver Node Estimator (DNE), a SAFE estimator, or a PMax estimator. The DNE uses only the GetNext calls at Driver Nodes when estimating progress. SAFE estimators and PMax estimators make estimations based on a pessimistic estimate of the remaining number of GetNext calls still to be issued at any point during query execution, minimizing different types worst-case error metrics. The candidate estimators may also include estimators that specifically account for batch sorts, estimators based on Index Seeks, and estimators based on cardinality interpolation. Index Seeks are standard operations of a database management system. The estimators 104 that account for batch sort or index seek operations give additional weight to the GetNext calls issued at nodes of this type. Estimators incorporating cardinality interpolation interpolate between the original optimizer-estimate of the total number of GetNext calls and the number of GetNext calls seen during query execution to derive an improved estimate of the total GetNext calls issued by a query execution.

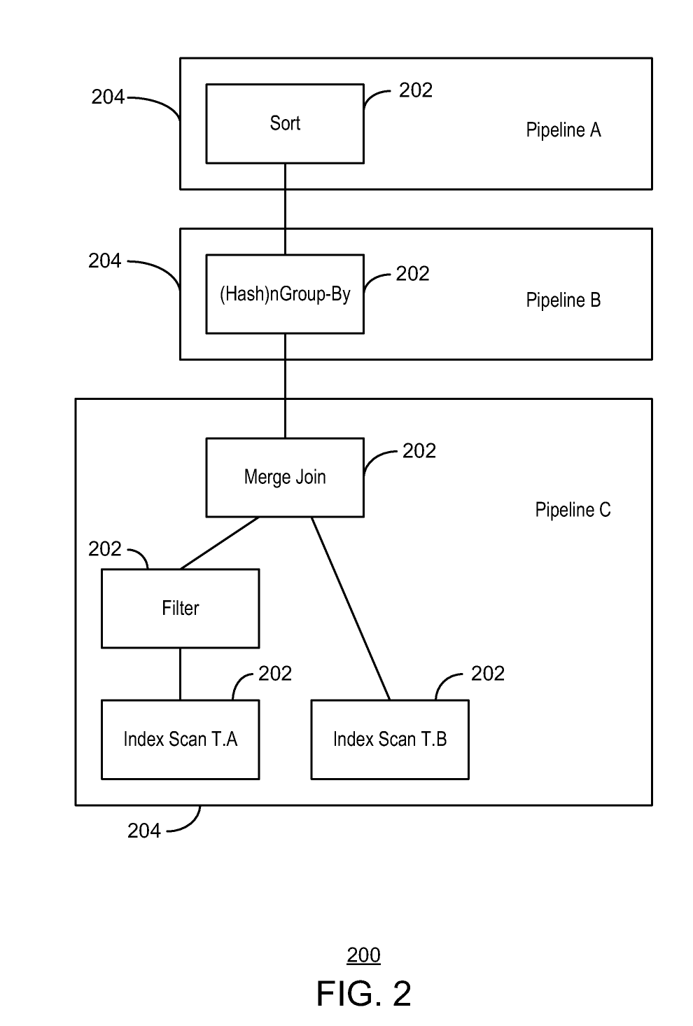

When invoked, the progress estimator 104 provides the progress estimate 106. The progress estimate 106 is an estimate of the overall query progress during execution. The queries 108 are database queries. The optimizer 110 generates the query plan 112 for a particular query 108. The query plan 112 is also referred to herein as the plan 112. The plan 112 describes to the query execution engine 114 how to process the query 108. The plan 112 is described in greater detail with reference to FIG. 2.

The optimizer 110 and execution engine 114 make available certain static features 116 and dynamic features 118, respectively. The static features 116 and dynamic features 118 are used by the selected progress estimator 104 to produce the progress estimate 106. The static features 116 and dynamic features are also used by the selector 102 to select, and potentially revise, the selected estimator 104.

The estimator 104 may be of various types, such as TotalGetNext estimator, a PMax estimator, or some other type. TotalGetNext (TGN) estimators refer to an estimator that uses the GetNext calls at all nodes of a query plan (as opposed to a suitably chosen subset).

Static features 116 are parameters whose values are determined before execution of the query plan 112. The static features 116 are typically based on the shape of the plan 112 and certain optimizer 110 estimates. The dynamic features 118 include information that only becomes available upon execution of the plan 112. The dynamic features may include, for example, counters from the query execution engine 114 and properties of the query execution.

In one embodiment, the selector 102 may select multiple progress estimators 104, a different estimator for each pipeline in the query plan 112. Pipelines are described in greater detail with reference to FIG. 2.

FIG. 2 is a block diagram of a query plan 200, in accordance with the claimed subject matter. The query plan 200 is represented as a binary tree, which includes nodes 202, organized into pipelines 204. Each node 202 represents an operation performed by the execution engine 114. The operations may be performed concurrently. Pipelines 204 correspond to maximal subtrees of consecutively executing nodes 202. Pipelines 204 are also referred to herein as segments. The set of all pipelines 204 for a query, Q, may be represented as shown in Equation 1:

Pipelines(Q)={P₁, . . . , P₁}, where each pipeline Pⱼ⊂Nodes(Q) (1)

For each pipeline 204, the nodes 202 that are the sources of tuples operated upon by the remaining nodes 202 of a pipeline 204 are referred to as the driver nodes. Typically, the driver nodes include all leaf nodes of a pipeline 204, excluding any inner subtree of nested loop operators. Leaf nodes are the nodes 202 at the bottom of a pipeline 204. For example, nodes 202 representing the index scan operations are the leaf nodes, and hence, the driver nodes of pipeline C. Pipelines A, B only include one node 202, which represent their driver nodes. The driver nodes for a pipeline, Pj, may be represented as shown in Equation 2:

DNodes(Pⱼ)⊂Pⱼ (2)

The driver nodes typically provide the dominant input of the pipeline, making them useful for determining progress estimation.

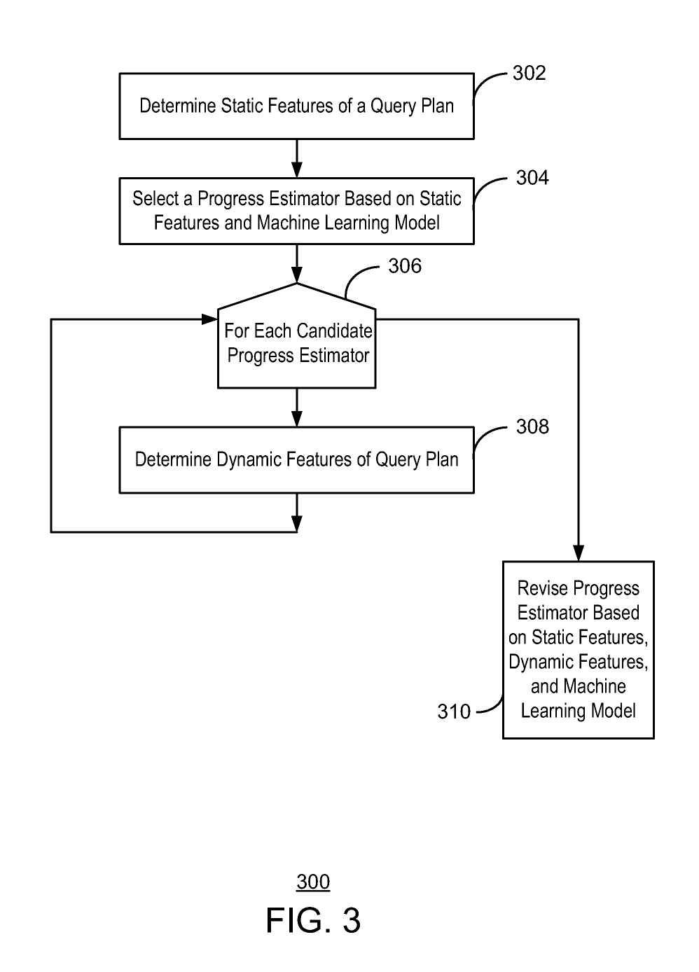

FIG. 3 is a process flow diagram of a method 300 for selecting the progress estimator 104, in accordance with the claimed subject matter. The method 300 may be performed by the selector 102. It is noted that the process flow diagram is not intended to indicate a particular order of execution.

The method 300 begins at block 302, where the selector 102 determines static features 116 of the query plan 112. The static features 116 include features that do not depend on feedback from query execution itself. Rather, the static features 116 may be derived from, for example, the plan 112 for a particular pipeline 204. Static features 116 may include metrics predicted using machine learning methods. These metrics may be associated with each physical operator type op known to the execution engine 114. For example, number of instances in the plan, e.g., Countₒₚ=|{i ∈ Nodes(Pⱼ): Operator(i)=op}|, may be static features 116 for each operator. Static features 116 may also include the cardinalities of tuples for each such operator type,

$${Card}_{op} = {Σ}_{i ∈ {Nodes ( {P}_{j} )}_{Operator ( i ) = op}} {E}_{i} .$$

The cardinalities and counts reference absolute cardinalities, which are useful in the context of execution time prediction. Absolute cardinalities can be misleading in the context of progress estimation. For example, when a nested loop join is expected to output 100K tuples, this might be negligible compared to the outer input being several millions of tuples. However, such a statistic may be very significant when the outer input is very small. Accordingly, the static features 116 may include relative cardinalities. Relative cardinalities may be relative to the estimated total number of tuples at nodes with an operator, op, as well as the relative cardinalities of their “input subtrees” and of the subtrees they feed into. Input subtrees and the subtress they feed into may be represented as shown in Equations 3-5:

$$\begin{matrix}{SelAt}_{op} = \frac{{Σ}_{i ∈ Nodes ( {P}_{j} ) ⋀ Operator ( i ) = op} {E}_{i}}{{Σ}_{i ∈ Nodes ( {P}_{j} )} {E}_{i}} & ( 3 ) \\ {SelAbove}_{op} = \frac{{Σ}_{i ∈ Nodes ( {P}_{j} ) \vert ∃ j : Operator ( j ) = op ⋀ j ∈ Ancestors ( i )} {E}_{i}}{{Σ}_{i ∈ Nodes ( {P}_{j} )} {E}_{i}} & ( 4 ) \\ {SelBelow}_{op} = \frac{{Σ}_{i ∈ Nodes ( {P}_{j} ) \vert ∃ j : Operator ( j ) = op ⋀ i ∈ Ancestors ( j )} {E}_{i}}{{Σ}_{i ∈ Nodes ( {P}_{j} )} {E}_{i}} & ( 5 )\end{matrix}$$

Referring back to FIG. 2, the value of the operator for the “Merge Join” includes the Eᵢ values of the “Filter” node and the two index scan nodes. With regard to the “Filter” subtree includes the Eᵢ value at the “Merge Join.” The static features 116 also include the cardinalities relative to the estimated total number of tuples of all driver nodes in a pipeline 204 in the feature SelAt_{DN}. The feature SelAt_{DN} refers to the set if all Driver Nodes.

The static features 116 also include the estimated number of GetNext calls, which are represented herein as Eᵢ. The GetNext calls may be determined from the plan 112, and refer to 334457.01 . . . Further, the estimated number of bytes processed may be determined by multiplying Eᵢ with the average row width. The estimated bytes processed may be useful for progress estimation.

Referring back to FIG. 3, at block 304, the selector 102 selects the progress estimator 104 based on the static features 116 of the candidate estimators and a machine learning model. The machine learning model may be trained offline, e.g., in a batch process, using static features 116 and dynamic features 118 of a specified set of query plans 112. The specified set may include a representative set of database queries capturing all operators supported by the database management system as well as a large variety of query plans and data distributions.

The selector 102 selects the estimator with the smallest estimation error among the candidate estimators. Further, because progress estimators for different pipelines are independent and can be combined as a weighted sum, the selector 102 may select potentially different estimators for each pipeline, or segment, in the query plan 112.

Blocks 306-308 may be performed for each candidate progress estimator, in order to improve the estimator 104 selected as the query 108 executes. At block 308, the selector 102 determines the dynamic features 118. The dynamic features 118 are determined after the query 108 has started execution. The dynamic features are also used for estimator selection. Using the dynamic features, the initial choice of progress estimators 104 may be revised, repeatedly, as a query executes. In this manner, the progress estimator selection may continually improve throughout execution. Advantageously, the progress estimates 106 may improve.

The estimation errors for progress estimators are typically a function of either the variance in the amount of work done for the tuples from the driver node input over the different observations, or the cardinality estimation errors made by the optimizer 110. These parameters cannot be reliably assessed before query execution. However, for many pipelines, both of these factors may be estimated with some degree of accuracy by monitoring the flow of tuples during the pipeline's execution. Under the assumption of nearly random tuple orderings and limited skew, the initial estimates of both of these factors become rather accurate after only a small fraction of the query has executed. Accordingly, this determination may allow the selector to revise the estimator 104 selected. While worst-case results of many estimators hold, these rely on adversarially chosen data orderings, which are highly unlikely in practice. Adverserially chosen data orderings represent a strong correlation between these factors and the order in which tuples are retrieved.

The dynamic features 118 may include the observed variance in the number of GetNext calls triggered by tuples read from the driver nodes. Additionally, the dynamic features 118 include relative differences in estimation provided by different progress estimators at different points in a query's execution. For example, the difference between the progress estimate provided using the two progress estimators, DNE and TGN, for a nested-loop join pipeline. If both progress estimators 104 make similar progress during the initial part of the query, but the TGN estimator subsequently makes much more rapid progress, this can be an indicator of some tuples from the driver node joining with a large number of tuples on the inner side of the join. This may indicate large variance in per input-tuple work.

The selector may compute the differences between estimators at consistent points in query execution so that there are similar points of reference when training the estimator selection model. The selector 102 uses the fraction of the driver node input, the size of which is known up-front for many queries, that has been consumed to create these markers when generating a feature. In order to compare these features for different queries (and thus learn from them), the features are computed at ‘similar’ points in time. Here, the t{x} represent these markers. For clarity, t{x}∈ Observations(Q) represent the first observation for which x % of the driver node input is consumed’. In other words,

$$( \frac{{Σ}_{( i ∈ DNodes )} {K}_{i}^{t}}{{Σ}_{i ∈ DNodes} {E}_{i}^{t}} ) \geq \frac{x}{100} .$$

Additionally, the notation DNE^{(t{x})} represents the estimate of progress for a progress estimator, DNE, at observation t{x}, and similarly for other progress estimators 104. The difference between estimators, DNE and TGN at x % of query execution is represented as shown in Equation 6:

DNEvsTGNₓ=∥DNE^{t{x}}−TGN^{t{x}}∥. (6)

These differences, for x∈{1,2,5,10,20}. may be used as dynamic features 118 in estimator selection between any two progress estimators 104. The selector 102 also uses the dynamic features 118 to quantify how well the estimators 104 correlate with time over the fraction of the query observed until time, t. For this purpose, a sequence of k observations may be represented as t{x/k},t{(2x)/k}, . . . , t{(kx)/k}. For each observation, the selector 102 may determine the fraction of time since the start of the query and the fraction of progress, to which, the different estimators correspond. For example, for the DNE estimator, the following dynamic features 118 may be determined for i=1, . . . , k, represented in Equation 7:

$${Cor}_{DNE , i , x} = \frac{Time ( t \{ ix / k \} ) - Time ( {t}_{start} )}{Time ( t \{ x / k \} ) - Time ( {t}_{start} )} \cdot \frac{1}{{DNE}^{t \{ x \}}} \qquad ( 7 )$$

At block 310, the selector 102 selects the estimator with the smallest predicted error based on a machine learning model. In one embodiment, the selector 102 trains a machine learning model that, for a given query pipeline 204, models the estimation error when using a specific estimator 104. In one embodiment, the machine learning model may be a regression model.

Training the regression model is a learning task that is different from, and advantageously simpler than predicting the specific runtime of query 108 before execution. Rather, the selector leverages fairly simple structural properties of pipelines 204, e.g., the presence of nested loop joins, which by themselves do not give any direct hints regarding absolute runtime. This is typically an issue for DNE estimators. Further, the selector offers various forms of online adaptivity, such as online cardinality refinement, which can offset optimization errors and the dynamic features 118 obtained as the query is executing, allowing the revision of initial selections.

Cardinality refinement refers to estimates of the number of tuples at different operators. However, unlike e.g., query optimization, progress estimation can easily leverage improved estimates obtained after a query has started to execute. For example, changing query plans mid-flight is a non-trivial operation.

In one embodiment, the selector 102 is based on Multiple Additive Regression-Trees. MART is based on a Stochastic Gradient Boosting paradigm, which performs gradient descent optimization in the functional space. In such and embodiment, the root mean square error is used as the loss function for optimization criterion. A steepest-decent gradient descent is used as the optimization technique, and binary decision trees are used as the fitting function. Advantageously, this is a non-parametric approach that applies numerical optimization in functional space.

In an iterative boosting, or residue-learning, paradigm, at the beginning of every iteration, the estimation errors of the training data are computed using a current model. The error prediction is compared with the actual error outcome to derive the errors (or residuals) for the current estimator 104, which is then used to fit a residue model. A function is used that approximates the errors using MSE (Mean Square Error) criteria. In MART, the derivatives are calculated of the log-loss for each training data point as the residual, and the regression tree is used as the approximation function-residual model. The regression tree is a binary decision tree, where each internal node splits the features space into two by comparing the value of a chosen feature with a pre-computed threshold. Once a terminal node is reached, an optimal regression value is returned for all the data falling into the region. Further, the residual model is added back to the existing model so that the overall training error is compensated for and reduced for this iteration. The new model, the current plus the residual model, is then used as the current model for the next boosting/training iteration. A model after M boosting iterations is the sum of all M regression trees built.

In one example implementation of the selector, MART provides advantage in accuracy, is able to handle the diverse sets of dynamic features 118. MART does not use transformations to normalize the inputs into zero mean and unit variance, and advantage over other algorithms such as logistic regression or neural nets. Further, through its internal use of decision trees, which are able to break the domain of each feature arbitrarily, MART handles the non-linear dependencies between the feature values and the estimation errors without using explicit binning as a preprocessing step.

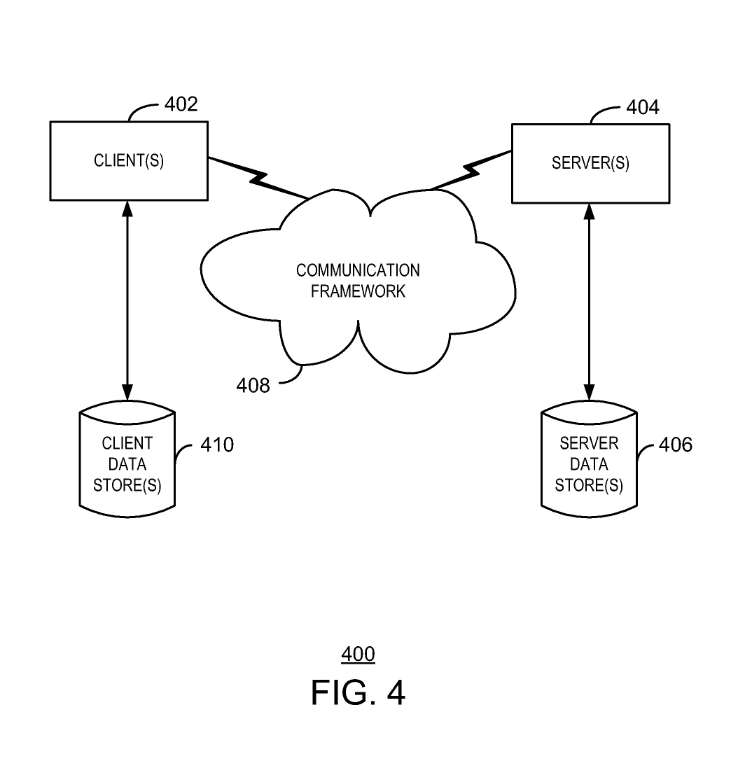

FIG. 4 is a block diagram of an exemplary networking environment 400 wherein aspects of the claimed subject matter can be employed. Moreover, the exemplary networking environment 400 may be used to implement a system and method that selects progress estimators 104 repeatedly during execution based on static features 116 and dynamic features 118, as described herein.

The networking environment 400 includes one or more client(s) 402. The client(s) 402 can be hardware and/or software (e.g., threads, processes, computing devices). As an example, the client(s) 402 may be computers providing access to servers over a communication framework 408, such as the Internet.

The environment 400 also includes one or more server(s) 404. The server(s) 404 can be hardware and/or software (e.g., threads, processes, computing devices). The server(s) 404 may include servers for the system 100. The server(s) 404 may be accessed by the client(s) 402.

One possible communication between a client 402 and a server 404 can be in the form of a data packet adapted to be transmitted between two or more computer processes. The environment 400 includes a communication framework 408 that can be employed to facilitate communications between the client(s) 402 and the server(s) 404.

The client(s) 402 are operably connected to one or more client data store(s) 410 that can be employed to store information local to the client(s) 402. The client data store(s) 410 may be located in the client(s) 402, or remotely, such as in a cloud server. Similarly, the server(s) 404 are operably connected to one or more server data store(s) 406 that can be employed to store information local to the servers 404.

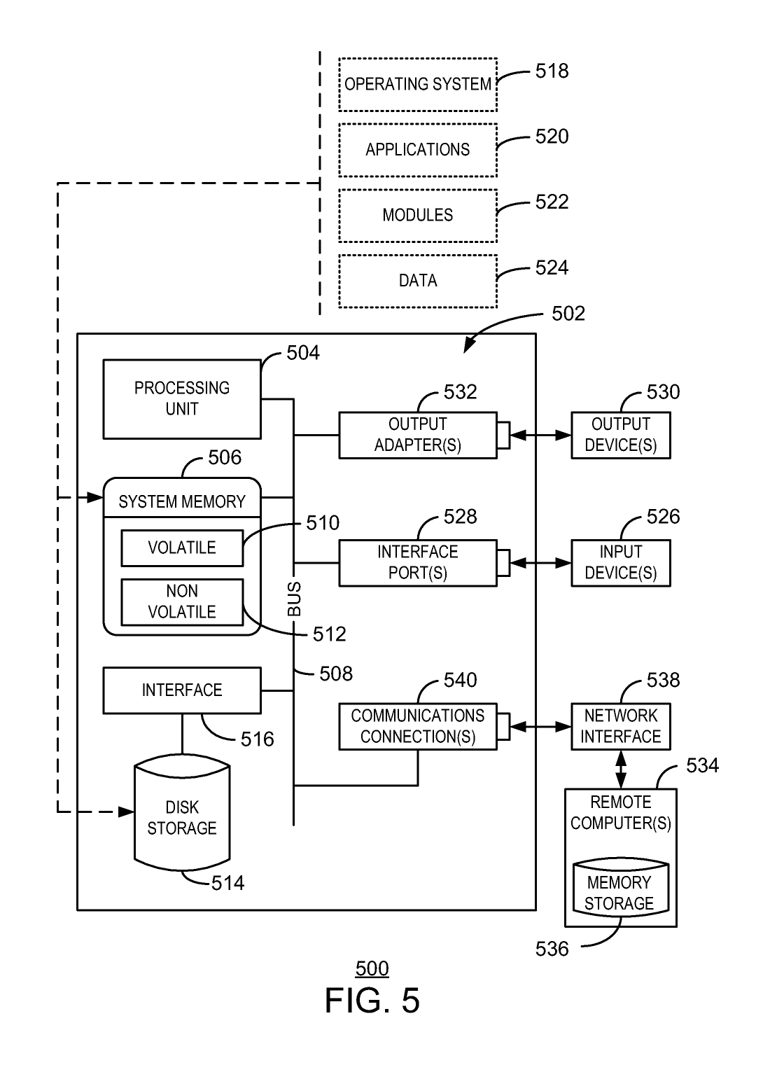

With reference to FIG. 5, an exemplary operating environment 500 is shown for implementing various aspects of the claimed subject matter. The exemplary operating environment 500 includes a computer 502. The computer 502 includes a processing unit 504, a system memory 506, and a system bus 508.

The system bus 508 couples system components including, but not limited to, the system memory 506 to the processing unit 504. The processing unit 504 can be any of various available processors. Dual microprocessors and other multiprocessor architectures also can be employed as the processing unit 504.

The system bus 508 can be any of several types of bus structure(s) including the memory bus or memory controller, a peripheral bus or external bus, and/or a local bus using any variety of available bus architectures known to those of ordinary skill in the art. The system memory 506 comprises non-transitory computer-readable storage media that includes volatile memory 510 and nonvolatile memory 512.

The basic input/output system (BIOS), containing the basic routines to transfer information between elements within the computer 502, such as during start-up, is stored in nonvolatile memory 512. By way of illustration, and not limitation, nonvolatile memory 512 can include read only memory (ROM), programmable ROM (PROM), electrically programmable ROM (EPROM), electrically erasable programmable ROM (EEPROM), or flash memory.

Volatile memory 510 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), SynchLink™ DRAM (SLDRAM), Rambus® direct RAM (RDRAM), direct Rambus® dynamic RAM (DRDRAM), and Rambus® dynamic RAM (RDRAM).

The computer 502 also includes other non-transitory computer-readable media, such as removable/non-removable, volatile/non-volatile computer storage media. FIG. 5 shows, for example a disk storage 514. Disk storage 514 includes, but is not limited to, devices like a magnetic disk drive, floppy disk drive, tape drive, Jaz drive, Zip drive, LS-100 drive, flash memory card, or memory stick.

In addition, disk storage 514 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 514 to the system bus 508, a removable or non-removable interface is typically used such as interface 516.

It is to be appreciated that FIG. 5 describes software that acts as an intermediary between users and the basic computer resources described in the suitable operating environment 500. Such software includes an operating system 518. Operating system 518, which can be stored on disk storage 514, acts to control and allocate resources of the computer system 502.

System applications 520 take advantage of the management of resources by operating system 518 through program modules 522 and program data 524 stored either in system memory 506 or on disk storage 514. It is to be appreciated that the claimed subject matter can be implemented with various operating systems or combinations of operating systems.

A user enters commands or information into the computer 502 through input device(s) 526. Input devices 526 include, but are not limited to, a pointing device (such as a mouse, trackball, stylus, or the like), a keyboard, a microphone, a joystick, a satellite dish, a scanner, a TV tuner card, a digital camera, a digital video camera, a web camera, and/or the like. The input devices 526 connect to the processing unit 504 through the system bus 508 via interface port(s) 528. Interface port(s) 528 include, for example, a serial port, a parallel port, a game port, and a universal serial bus (USB).

Output device(s) 530 use some of the same type of ports as input device(s) 526. Thus, for example, a USB port may be used to provide input to the computer 502, and to output information from computer 502 to an output device 530.

Output adapter 532 is provided to illustrate that there are some output devices 530 like monitors, speakers, and printers, among other output devices 530, which are accessible via adapters. The output adapters 532 include, by way of illustration and not limitation, video and sound cards that provide a means of connection between the output device 530 and the system bus 508. It can be noted that other devices and/or systems of devices provide both input and output capabilities such as remote computer(s) 534.

The computer 502 can be a server hosting various software applications in a networked environment using logical connections to one or more remote computers, such as remote computer(s) 534. The remote computer(s) 534 may be client systems configured with web browsers, PC applications, mobile phone applications, and the like.

The remote computer(s) 534 can be a personal computer, a server, a router, a network PC, a workstation, a microprocessor based appliance, a mobile phone, a peer device or other common network node and the like, and typically includes many or all of the elements described relative to the computer 502.

For purposes of brevity, only a memory storage device 536 is illustrated with remote computer(s) 534. Remote computer(s) 534 is logically connected to the computer 502 through a network interface 538 and then connected via a wireless communication connection 540.

Network interface 538 encompasses wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 540 refers to the hardware/software employed to connect the network interface 538 to the bus 508. While communication connection 540 is shown for illustrative clarity inside computer 502, it can also be external to the computer 502. The hardware/software for connection to the network interface 538 may include, for exemplary purposes only, internal and external technologies such as, mobile phone switches, modems including regular telephone grade modems, cable modems and DSL modems, ISDN adapters, and Ethernet cards.

An exemplary processing unit 504 for the server may be a computing cluster comprising Intel® Xeon CPUs. The disk storage 514 may comprise an enterprise data storage system, for example, holding thousands of impressions.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and/or events of the various methods of the claimed subject matter.

There are multiple ways of implementing the subject innovation, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the subject innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for generating a progress estimate for a database query, comprising:
determining static features of a query plan for the database query;
selecting an initial progress estimator based on the static features and a trained machine learning model that is trained using static features of a plurality of query plans, and dynamic features of the plurality of query plans;
determining dynamic features of the query plan for each of a plurality of candidate estimators;
selecting a revised progress estimator, for each of the candidate estimators, based on the static features, the dynamic features and the trained machine learning model; and
generating the progress estimate based on the revised progress estimator.

2. The method recited in claim 1, comprising generating an initial progress estimate using the initial progress estimator, wherein the progress estimate is more accurate than the initial progress estimate.

3. The method recited in claim 1, wherein the query plan comprises a pipeline of a larger query plan.

4. The method recited in claim 3, wherein the query plan comprises a plurality of pipelines within the larger query plan.

5. The method recited in claim 4, comprising selecting a progress estimator for each of the pipelines.

6. The method recited in claim 1, wherein the trained machine learning model comprises a regression model that is based on multiple additive regression trees (MART).

7. The method recited in claim 6, wherein the MART comprises:
a root mean square error as a loss function for an optimization criterion;
a steepest descent as an optimization technique; and
binary decision trees as a fitting function.

8. The method recited in claim 1, wherein the candidate progress estimators include at least one of:
TotalGetNext estimators;
PMax estimators;
SAFE estimators;
DriverNode estimators;
estimators specialized for batch operations;
estimators incorporating GetNext calls at IndexSeeks;
estimators with cardinality interpolation; or
combinations thereof.

11. A system for generating a progress estimate for a database query, comprising:
a processing unit; and
a system memory, wherein the system memory comprises code configured to direct the processing unit to:
determine static features of a query plan of the database query, wherein the static features include metrics about the query plan determined before execution of the query plan;
select an initial progress estimator based on the static features and a trained machine learning model that is trained using static features of a plurality of query plans, and dynamic features of the plurality of query plans;
determine dynamic features of the query plan for each of a plurality of candidate estimators, wherein the dynamic features include metrics about an execution of the query plan;
select a revised progress estimator, for each of the candidate estimators, based on the static features, the dynamic features and the trained machine learning model;
generate the progress estimate based on the revised progress estimator, wherein the progress estimate is more accurate than the initial progress estimate.

12. The system recited in claim 11, wherein the query plan comprises a pipeline of a larger query plan.

13. The system recited in claim 12, wherein the query plan comprises a plurality of pipelines within the larger query plan.

14. The system recited in claim 13, comprising code configured to direct the processing unit to select a progress estimator for each of the pipelines.

15. The system recited in claim 11, wherein the trained machine learning model is a regression model that is based on multiple additive regression trees (MART).

16. The system recited in claim 15, wherein the MART comprises:
a root mean square error as a loss function for an optimization criterion;
a steepest descent as an optimization technique; and
binary decision trees as a fitting function.

17. The system recited in claim 11, wherein the candidate progress estimators include at least one of:
TotalGetNext estimators;
PMax estimators;
SAFE estimators;
DriverNode estimators;
estimators specialized for batch operations;
estimators incorporating GetNext calls at IndexSeeks;
estimators with cardinality interpolation; or
combinations thereof.

18. One or more computer-readable storage media, comprising code configured to direct a processing unit to:
determine static features of a pipeline of a query plan for a database query, wherein the static features include metrics about the pipeline determined before execution of the query plan;
select an initial progress estimator for the pipeline based on the static features and a trained regression model that is trained using static features of a plurality of query plans and dynamic features of a plurality of query plans;
determine dynamic features of the pipeline for each of a plurality of candidate estimators, wherein the dynamic features include metrics about an execution of the pipeline;
select a revised progress estimator, for each of the candidate estimators, based on the static features, the dynamic features and the trained regression model;
generate the progress estimate based on the revised progress estimator, wherein the progress estimate is more accurate than the initial progress estimate.

19. The computer-readable storage media recited in claim 18, wherein the query plan comprises a plurality of pipelines within the larger query plan, and comprising code configured to direct the processing unit to select a progress estimator for each of the pipelines.

20. The computer-readable storage media recited in claim 18, wherein the trained regression model is based on multiple additive regression trees (MART), and wherein the MART comprises:
a root mean square error as a loss function for an optimization criterion;
a steepest descent as an optimization technique; and
binary decision trees as a fitting function.
